(19) United States
(12) Patent Application Publication
(10) Pub. No.: US 2020/0081194 A1
(43) Pub. Date: Mar. 12, 2020

(54) LENS FERRULE

(71) Applicant: FUJITSU COMPONENT LIMITED, Tokyo (JP)

(72) Inventors: Hongfei Zhang, Tokyo (JP); Shinichiro Akieda, Tokyo (JP)

(21) Appl. No.: 16/561,223

(22) Filed: Sep. 5, 2019

(30) Foreign Application Priority Data
Sep. 10, 2018 (JP) 2018-168848

(51) Int. Cl. G02B 6/38

(52) U.S. Cl. CPC G02B 6/3825; G02B 6/3882

(57) ABSTRACT

A lens ferrule for connection to a second ferrule includes a plurality of lenses disposed in a recess formed in a contact face that comes in contact with the second ferrule, a slit formed in an insertion face opposite the contact face and configured to receive an optical waveguide, a through hole cut into the contact face and configured to receive a guide pin for positional alignment with the second ferrule, a lens-position reference plane configured to serve as a reference for measuring positions of the lenses, and a slit-position reference plane configured to serve as a reference for measuring a position of the slit, wherein the lens-position reference plane and the slit-position reference plane are disposed at different depths from the contact face in an area including the through hole.

### BACKGROUND OF THE INVENTION

### 1. Field of the Invention

The disclosures herein relate to a lens ferrule.

### 2. Description of the Related Art

Optical communications have been increasingly used for the high-speed interface of supercomputers and high-end servers. Optical modules are used for a next-generation interface studied for standards such as IBTA EDR (registered trademark), 100G Ethernet (registered trademark) which has a long transmission distance of a few ten meters. Optical modules used to couple optical cables to servers or the like convert optical signals into electrical signals, and also convert electrical signals into optical signals.

An optical cable employs an optical connector connecting an optical cable and an optical waveguide. An optical connector includes an MT ferrule coupled to an optical cable and a lens ferrule coupled to an optical waveguide (see Patent Document 1, for example).

When an optical waveguide is misaligned with an optical cable, light concentration efficiency for the optical cable drops, resulting in the risk of reduced optical transmission efficiency. Because of this, the contact point between a lens ferule and an MT ferrule requires high dimensional precision.

Accordingly, there may be a need for a lens ferrule that can improve measurement accuracy.

### RELATED-ART DOCUMENTS

### Patent Document

[Patent Document 1] Japanese Patent Application Publication No. 2015-22125

### SUMMARY OF THE INVENTION

According to an embodiment, a lens ferrule for connection to a second ferrule includes a plurality of lenses disposed in a recess formed in a contact face that comes in contact with the second ferrule, a slit formed in an insertion face opposite the contact face and configured to receive an optical waveguide, a through hole cut into the contact face and configured to receive a guide pin for positional alignment with the second ferrule, a lens-position reference plane configured to serve as a reference for measuring positions of the lenses, and a slit-position reference plane configured to serve as a reference for measuring a position of the slit, wherein the lens-position reference plane and the slit-position reference plane are disposed at different depths from the contact face in an area including the through hole.

At least one embodiment provides a lens ferrule for which measurement accuracy is improved with respect to important dimensions.

### BRIEF DESCRIPTION OF THE DRAWINGS

FIG. 1 is an exploded axonometric view of an optical module;

FIG. 2 is an oblique view of a lens ferrule according to an embodiment;

FIG. 3 is a front view of the lens ferrule;

FIG. 4 is a side elevation view of the lens ferrule;

FIG. 5 is a cross-sectional view taken along the line I-I in FIG. 4;

FIG. 6 is a cross-sectional view taken along the line II-II in FIG. 3;

FIG. 7 is a cross-sectional view taken along the line III-III in FIG. 3;

FIGS. 8A and 8B are drawings illustrating lens-position measurement using an outer back wall as a lens reference plane;

FIGS. 9A and 9B are drawings illustrating slit position measurement using the back wall of a side recess as a slit reference plane;

FIG. 10 is an oblique view of the lens ferrule having guide pins mounted thereon;

FIG. 11 is an oblique view illustrating the lens ferrule and an MT ferrule connected to each other;

FIG. 12 is an oblique view of the lens ferrule according to a first variation;

FIG. 13 is an oblique view illustrating the lens ferrule of the first variation and the MT ferrule connected to each other;

FIG. 14 is an oblique view of the lens ferrule according to a second variation; and

FIG. 15 is a front view of the lens ferrule according to the second variation.

### DESCRIPTION OF EMBODIMENTS

In the following, embodiments will be described in detail by referring to the accompanying drawings. For the sake of easier understanding, the same elements are used for the same components throughout the drawings to the extent possible, and duplicate descriptions will be omitted.

### Embodiment

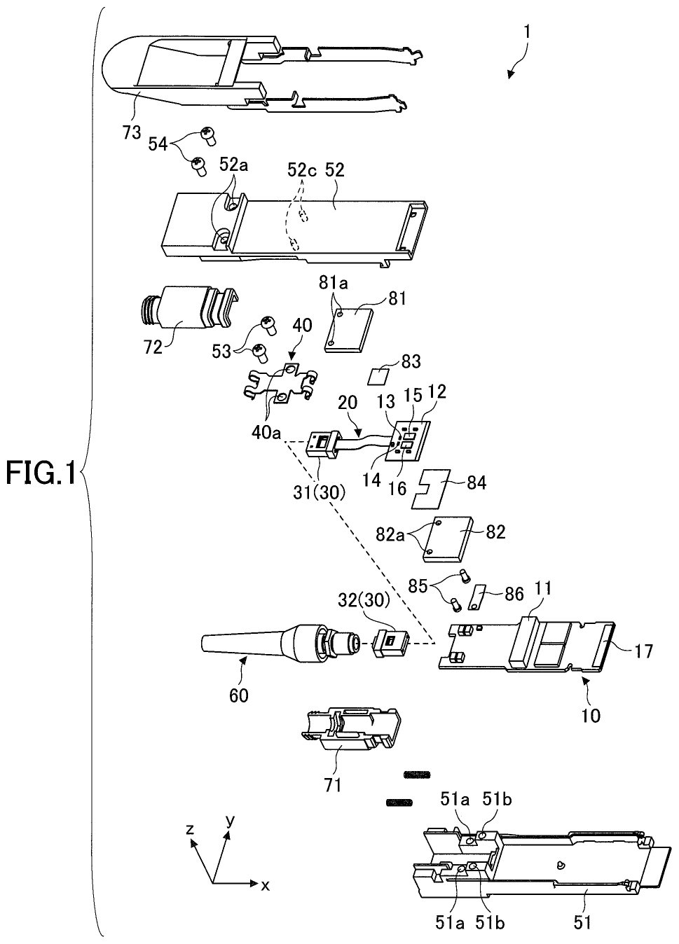

An embodiment will be described with reference to FIGS. 1 through 11. An optical module 1 to which a lens ferrule 31 of the present embodiment is applied will be described with reference to FIG. 1. FIG. 1 is an exploded axonometric view of the optical module 1.

In the following, three orthogonal axes will be used as a reference for explaining the shape and relative arrangement of components in the optical module 1. As illustrated in FIG. 1, the x axis extends in the longitudinal direction of the optical module 1, and the y axis extends in the width direction of the optical module 1, with the z axis extending in a vertical direction. A face facing the +z direction is an upper face, and a face facing the −z direction is a lower face.

As illustrated in FIG. 1, the optical module 1 includes a printed circuit board (PCB) 10, an optical waveguide 20, a ferrule 30, and a clip 40, which are housed in a case having a lower cover 51 and an upper cover 52, with a multi-core optical cable 60 including a plurality of optical fibers connected thereto. The upper cover 52 and the lower cover 51 may be zinc die-cast parts.

The PCB 10 is provided with an FPC connector 11 for connecting an FPC 12. The FPC 12 has light emitters 13 such as VCSELs (vertical cavity surface emitting lasers) for converting electrical signals into optical signals, light receivers 14 such as photo diodes for converting optical signals into electrical signals, a driver IC 15 for driving the light emitters 13, and a TIA 16 for converting currents from the light receivers 14 into voltages. One end of the PCB 10 has connection terminals 17 for connection with an external device. The PCB 10 is disposed on the lower cover 51.

In the following, the light emitters 13 and the light receivers 14 are collectively referred to as “photoelectric converter”. The driver IC 15 and the TIA 16 are collectively referred to as “semiconductor devices”.

One end of the optical waveguide 20 is connected to the FPC 12, and the other end is connected to the lens ferrule 31. The connection point between the optical waveguide 20 and the lens ferrule 31 is protected with a ferrule boot (not shown).

The ferrule 30 includes the lens ferrule 31 and an MT (mechanically transferable) ferrule 32 (second ferrule). The lens ferrule 31 and the MT ferrule 32 are clamped and secured by a clip 40. The MT ferrule 32 is capable of connecting multicore optical fibers together. The lens ferrule 31 is configured to cope with high density corresponding to the MT ferrule 32. For example, a QSFP (quad small form factor pluggable) type optical connector has the MT ferrule 32 and the lens ferrule 31. The optical cable 60 connected to the MT ferrule 32 and the optical waveguide connected to the lens ferrule 31 are coupled to each other by abutting the MT ferrule 32 with the lens ferrule 31.

The ferrule 30 is disposed on the lower cover 51. The clip 40 with two screw holes 40a is engaged with two female threaded portions 51a provided in the lower cover 51 with screws 53. The ferrule 30 is secured on the lower cover 51 by fixing the clip 40 to the lower cover 51.

The FPC 12 is interposed between an upper inner case 81 and a lower inner case 82. The upper inner case 81 covers the upper face of the FPC 12, and the lower inner case 82 covers the lower face of the FPC 12. The upper inner case 81 and the lower inner case 82 is made of a material harder, and having a higher heat dissipation property, than the FPC 12.

A heatsink sheet 83 is disposed on the upper face of the FPC 12, and is inserted between the upper inner case 81 and the FPC 12. The heatsink sheet 83 conducts the heat generated by the photoelectric converters and the semiconductor devices to the upper cover 52 for heat dissipation. The heatsink sheet 83 has at least such a size as to come in contact with, and cover, the upper faces of photoelectric converters and semiconductor devices. The heatsink sheet 83 has a silicon material as a main component, for example, and is flexible.

A radio-wave absorption sheet 84 is disposed between the FPC 12 and the lower inner case 82. The absorption sheet 84 has a recess such as to avoid overlapping the optical waveguide 20.

The lower face of the upper inner case 81 has a recess (not shown) into which the heatsink sheet 83 as well as the photoelectric converters and semiconductor devices are insertable. Two through holes 81a and two through holes 82a are provided near an edge of the upper inner case 81 and near an edge of the lower inner case 82, respectively.

The upper inner case 81, the heatsink sheet 83, the FPC 12, the absorption sheet 84, and the lower inner case 82 are stacked together and fixed to the upper cover 52. The heatsink sheet 83 and the FPC 12 are inserted into the recess of the upper inner case 81, and the absorption sheet 84 is disposed beneath the lower face of the FPC 12, with the lower inner case 82 being attached thereto. The through holes 81a and the through holes 82a are securely held by screws 85 to threaded portions 52c provided in the lower face of the upper cover 52.

A leaf spring 86 is disposed between the lower inner case 82 and the PCB 10. The spring 86 is disposed substantially at the center of the lower inner case 82, preferably directly below the heatsink sheet 83, and is sandwiched between the lower inner case 82 and the PCB 10 to apply pressure toward the upper cover 52.

The end of the optical cable 60 connected to the MT ferrule 32 is covered with cable boots 71 and 72 on the upper and lower sides thereof. A latch 73 is mounted on the optical module 1.

The ferrule 30 secured to the lower cover 51 and the PCB 10 mounted on the lower cover 51 are covered with the upper cover 52 on which the FPC 12 is fixedly mounted. Screw holes 52a of the upper cover 52 are securely held by screws 54 to threaded portions 51b of the lower cover 51.

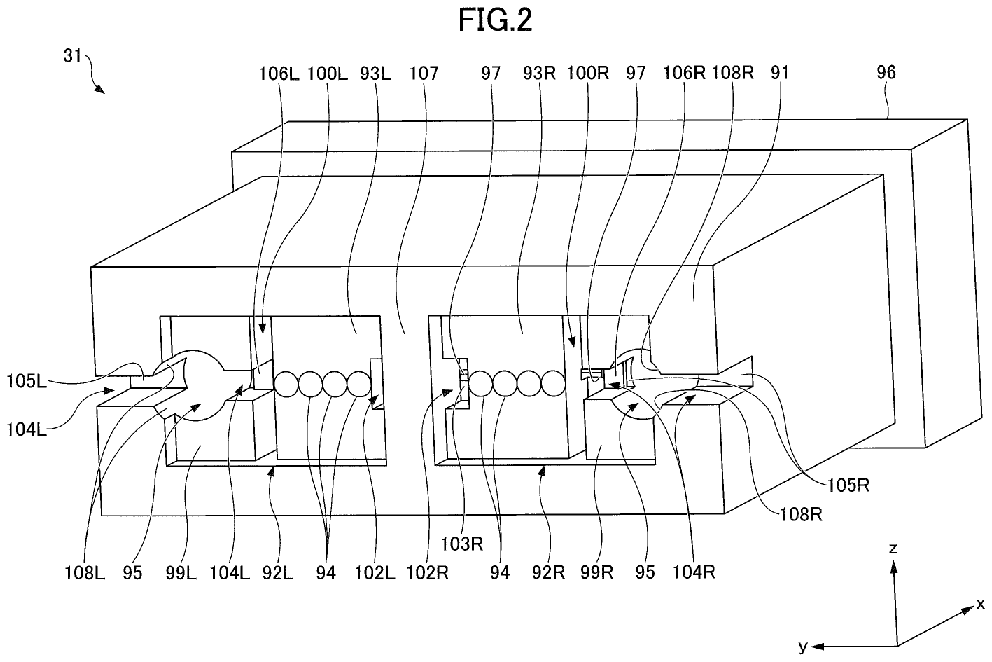

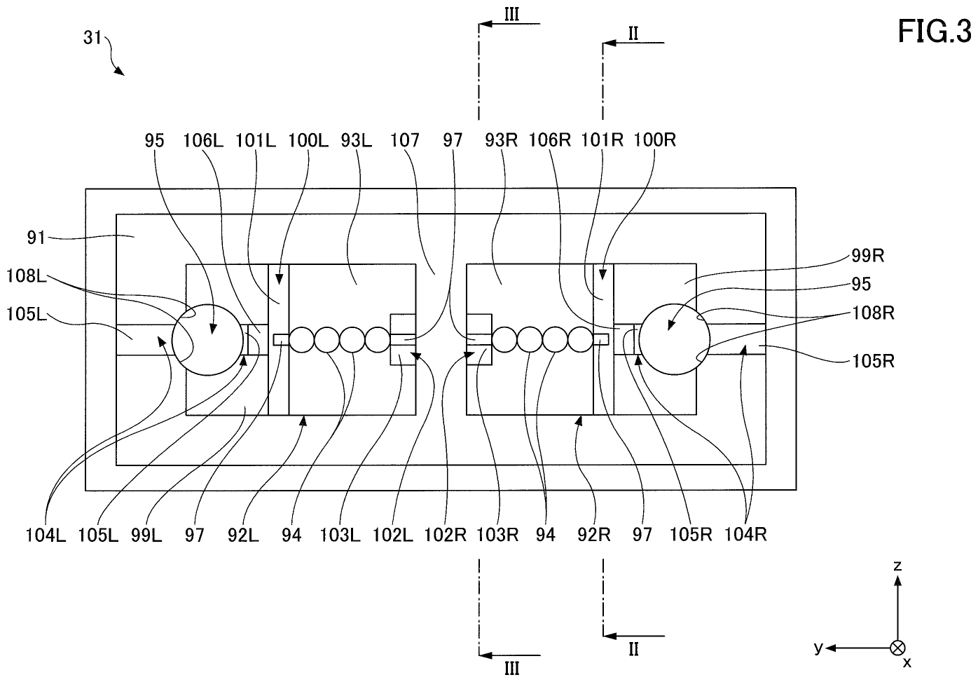

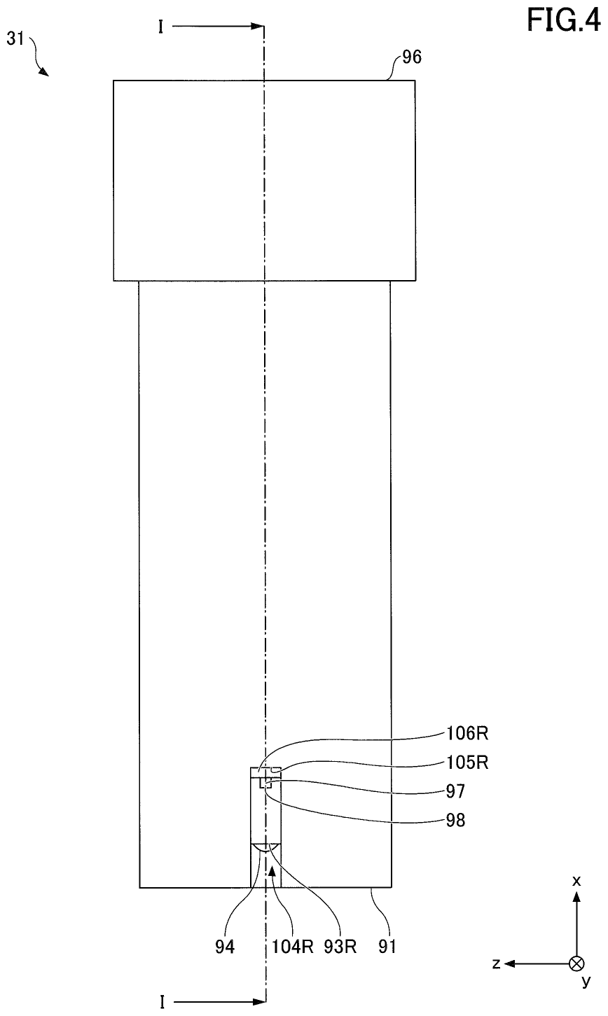

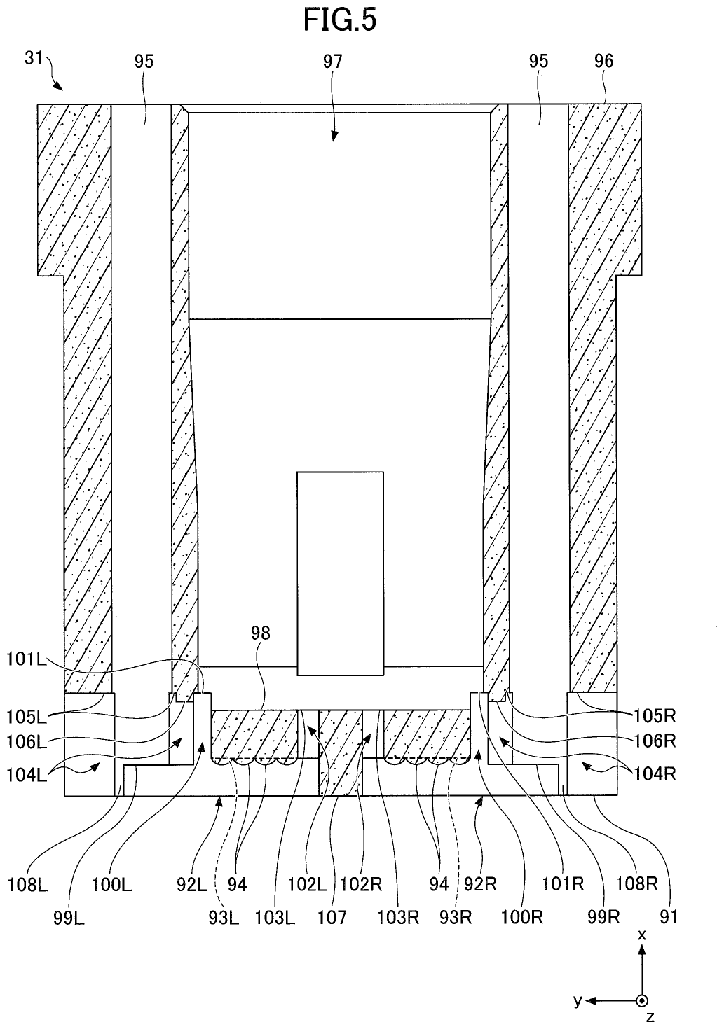

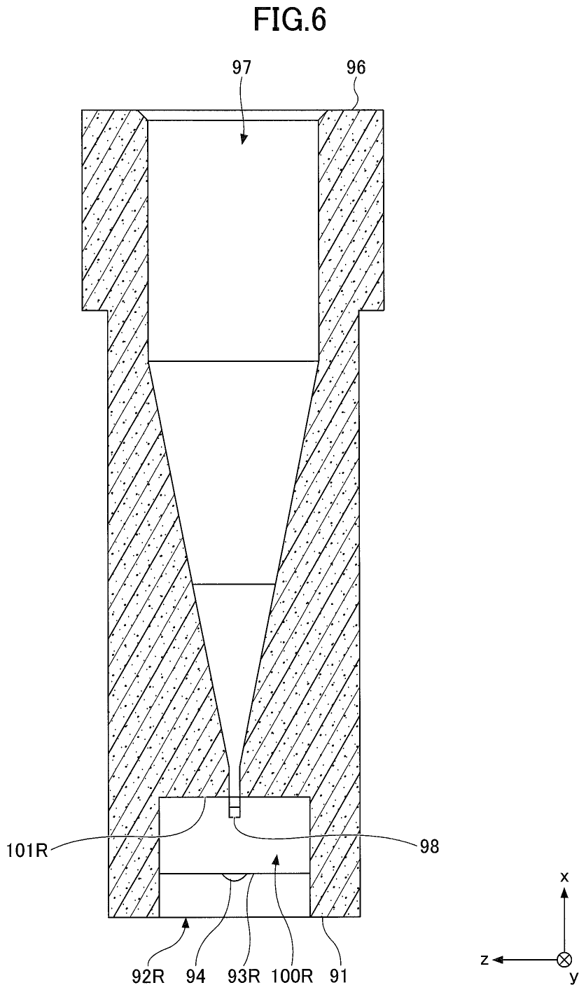

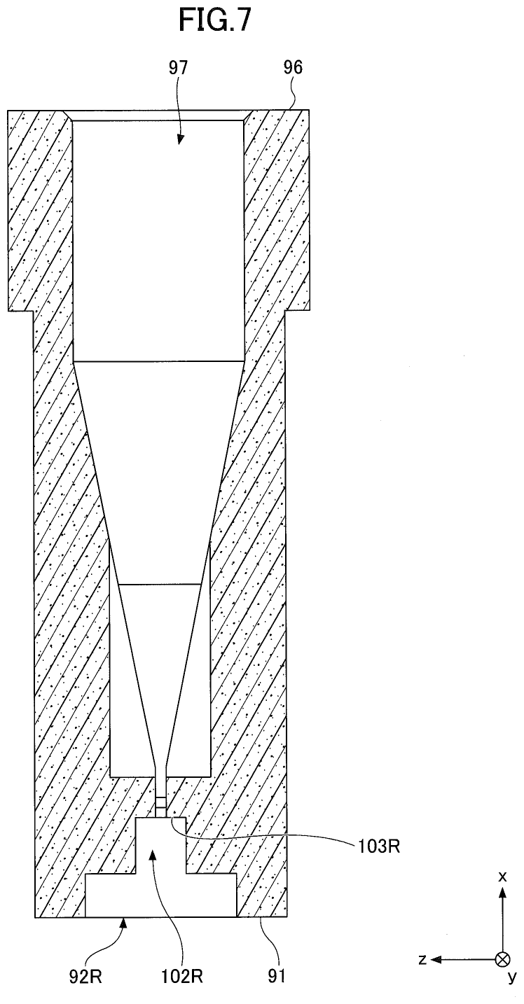

The lens ferrule 31 will be described with reference to FIGS. 2 through 7. FIG. 2 is an oblique view, FIG. 3 is a front view, and FIG. 4 is a side elevation view of the lens ferrule 31. FIG. 5 is a cross-sectional view taken along the line I-I in FIG. 4. FIG. 6 is a cross-sectional view taken along the line II-II in FIG. 3. FIG. 7 is a cross-sectional view taken along the line III-III in FIG. 3.

As illustrated in FIGS. 2 and 3, the lens ferrule 31 has a contact face 91 that comes in contact with the MT ferrule 32. The lens ferrule 31 is connected to the MT ferrule 32 in a series arrangement. The contact face 91 has two recesses 92L and 92R. Lenses 94 are formed on the back walls of the recesses 92L and 92R near the horizontal center of the contact face 91. The lenses 94 are arranged in a straight line along the y axis. The recesses 92L and 92R are formed by cutting holes into the contact face 91.

The lens ferrule 31 is formed of a transparent resin such as COP (cyclo-olefin polymer) or PBS (polybutylene succinate). The lenses 94 are formed at the same time as when the lens ferrule 31 is formed. The lenses 94 are formed as hemispherical convex parts projecting from back walls 93L and 93R.

The positions of the lenses 94 have one-to-one correspondence with the positions of holes formed in the MT ferrule 32 at the position of the tip of the optical cable 60. Through holes 95 are formed in the contact face 91 near both ends of the array of the lenses 94, into which guide pins 110 are inserted in order to align the MT ferrule 32 with the lens ferrule 31. The through holes 95 extend between the contact face 91 and an insertion face 96 as illustrated in FIG. 5.

As illustrated in FIGS. 2 and 4, the lens ferrule 31 has the insertion face 96 opposite the contact face 91. As illustrated in FIGS. 5, 6 and 7, a slit 97 for inserting the optical waveguide 20 is cut into the insertion face 96 toward the inside of the ferrule 31.

As illustrated in FIGS. 6 and 7, the slit 97 is the widest in the z direction at the insertion face 96, and gradually narrows toward the −x direction. The end wall of the slit 97 is a slit back wall 98. The slit 97 is the narrowest in the z direction around the back wall 98. The upper face and lower face of the slit 97 are inclined in the x direction, with a gap decreasing toward the deeper part of the slit 97. A rubber boot is fit into the entrance of the slit 97 near the insertion face 96 in order to hold the optical waveguide 20.

In the lens ferrule, the positions of lenses and the positions of optical waveguide cores need to be aligned within some tolerance. For the purpose of quality inspection of the product, the position of the slit of the lens ferrule and the positions of lenses are checked to determine whether the major parts of the lens ferrule have sufficient dimensional accuracy.

Guide pins are inserted into the through hole formed in the contact face when connecting the lens ferrule to the MT ferrule. The positions of the guide-pin through holes may serve as a reference point for use in measuring the positions of various parts of the lens ferrule.

An image of the lens ferrule may be taken from the contact-face side to evaluate the positions of the lenses and the slit. Further, the centers of the through holes situated at both ends of an array of the lenses and the centers of the lenses may be detected to evaluate error in the positions of the lenses. When the end faces of the lenses and the end face of the slit are situated at a plane different from the contact face of the lens ferrule, an inclination of the ferrule relative to the imaging direction may create a displacement between the lenses or the slit and the through holes serving as a reference point, thereby lowering measurement accuracy.

Further, when an image of the lens ferrule is taken from the contact-face side, it is difficult to measure the distance between the back wall 98 and the back walls 93L and 93R serving as the base for the lenses, and, also, it is difficult to measure the distance in the x direction between the base of the lenses and the contact face 91.

In the following, a lens ferrule that allows parts thereof to be measured without causing the above-noted problems will be described.

As illustrated in FIGS. 2 and 3, grooves 100L and 100R extending in the z direction are formed at the center of the recesses 92L and 92R, respectively. Each of the back walls of the recesses 92L and 92R is divided into halves in the y direction by the grooves 100L and 100R, respectively. The halves closer to the center of the ferrule than the grooves 100L and 100R are the back walls 93L and 93R, respectively, and the halves on the outside with respect to the grooves 100L and 100R are outer back walls 99L and 99R, respectively.

The back walls 99L and 99R include the centers S_{L1} and S_{R1} of the through holes 95. The back walls 99L and 99R are lens reference planes which serve as references for measuring the positions of the lenses 94. The lens positions are measured by using the centers S_{L1} and S_{R1} as references. The back walls 99L and 99R are parallel to the back walls 93L and 93R, and are positioned in the same plane as the tops of the lenses 94 as illustrated in FIG. 5.

The grooves 100L and 100R are at a greater depth from the contact face 91 than the back walls 93L and 93R as well as than the back walls 99L and 99R. As illustrated in FIGS. 5 and 6, the back walls 101L and 101R of the respective grooves 100L and 100R are situated further toward the +x direction than the back wall 98. As illustrated in FIGS. 3 and 5, the grooves 100L and 100R are situated at the positions overlapping the opposite ends of the slit 97 in the width direction. The grooves 100L and 100R are cut to a depth at which the opposite ends of the slit 97 are exposed. With this arrangement, as illustrated in FIGS. 2 and 3, the grooves 100L and 100R expose, at the back walls 101L and 101R, the opposite ends of the slit 97 in the width direction. Further, as illustrated in FIG. 6, the deepest end of the slit 97 including the back wall 98 is exposed at the lateral walls of the grooves 100L and 100R.

As illustrated in FIGS. 2 and 3, center recesses 102L and 102R are formed in the back walls 93L and 93R at the vertical center and at the ends toward the horizontal center. The recesses 102L and 102R are situated at positions overlapping the center section of the slit 97, and are cut to a depth at which the center section of the slit 97 is exposed, as illustrated in FIGS. 5 and 7. With this arrangement, as illustrated in FIG. 3, the slit 97 is exposed at the back walls 103L and 103R of the respective recesses 102L and 102R. Here, the center section of the slit 97 refers to a section of the slit 97 between two points of the slit 97 exposed at the respective recesses 102L and 102R including the y-axis center of the slit 97.

As illustrated in FIGS. 2 through 4, side recesses 104L and 104R are formed in the contact face 91 on the outside with respect to the grooves 100L and 100R. The recesses 104L and 104R are cut into the contact face 91 to the same depth as the grooves 100L and 100R as illustrated in FIG. 5. As illustrated in FIGS. 4 and 5, the recesses 104L and 104R have deepest back walls 105L and 105R which are situated on the +x side with respect to the back wall 98. As illustrated in FIGS. 2 and 3, the recesses 104L and 104R are parallel to the y axis and intersect the through holes 95. The back walls 105L and 105R are formed to include the centers S_{L2} and S_{R2} of the through holes 95. The back walls 105L and 105R are a slit reference plane that serves as the reference for measuring the position of the slit 97. The slit position is measured with reference to the centers S_{L2} and S_{R2} at the back walls 105L and 105R.

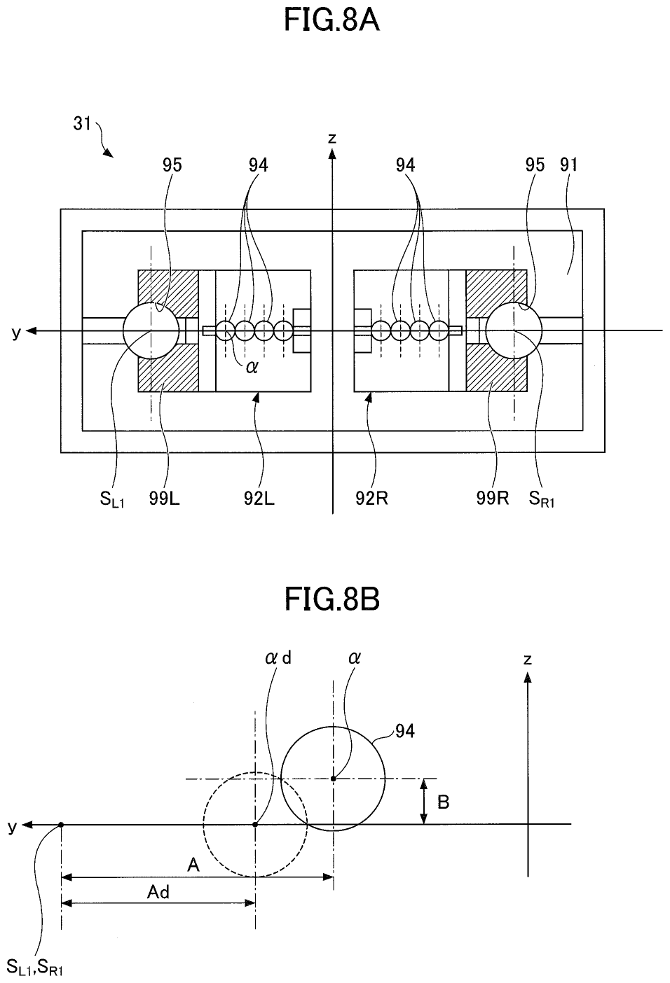

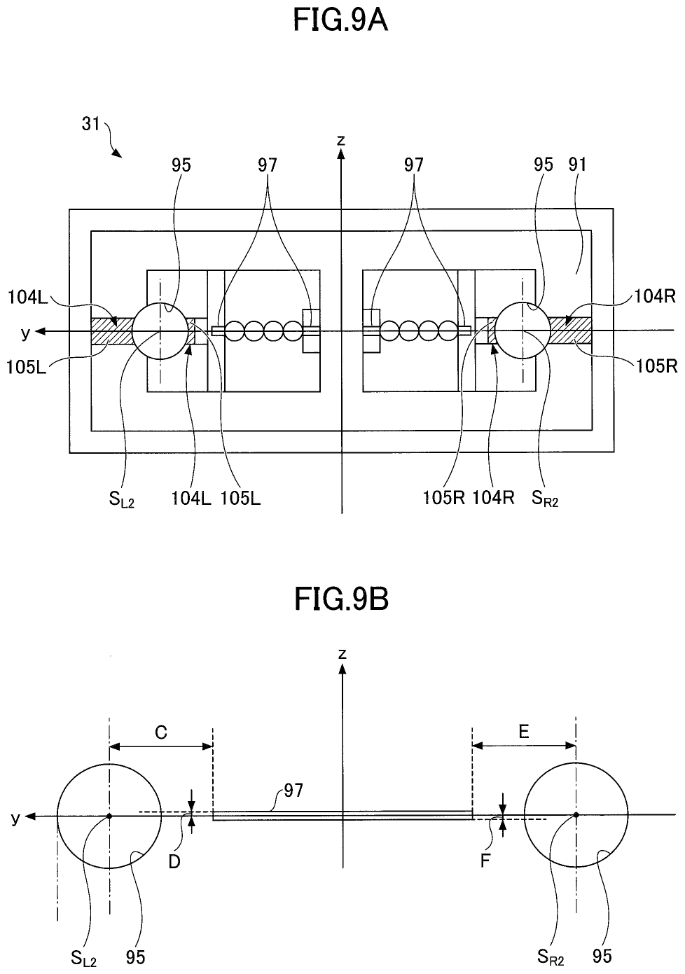

Referring to FIGS. 8A, 8B, 9A and 9B, measurement of the lens position and the slit position in the present embodiment will be described.

FIGS. 8A and 8B illustrate lens position measurement using the back walls 99L and 99R as the lens reference plane. FIG. 8A is a front view of the lens ferrule 31 illustrated with the yz coordinates. In FIG. 8A, the back walls 99L and 99R are shown with hatching. FIG. 8B schematically illustrates the measured dimensions in the yz coordinates. In FIG. 8A, the yz coordinates are defined on the plane including the back walls 99L and 99R. The y axis passes through the centers S_{L1} and S_{R1}. The z axis passes through the midpoint between the centers S_{L1} and S_{R1}, i.e., the center of the lens ferrule 31 in the y direction.

As illustrated in FIG. 8A, lenses 94 are arranged in a line along the y axis connecting the centers S_{L1} and S_{R1}, with the centers of the lenses 94 positioned on the y axis. With respect to any given lens 94 of interest, the geometric relationships between the lens 94 and the centers S_{L1} and S_{R1} are as illustrated in FIG. 8B. Design position of the center αd of the lens 94 is on the y axis, and the distance in the y direction from the center S_{L1} or S_{R1} is Ad, with the distance in the z direction being 0. However, it is assumed that the measured center a of the lens 94 is at a distance A in the y direction from the center S_{L1} or S_{R1}, and at a distance B in the z direction from the center S_{L1} or S_{R1}. The deviations of the lens 94 in the y direction and in z directions can be determined from the design dimensions and the measured dimensions. When the difference between the distance A and the distance Ad and the magnitude of the distance B are within an acceptable range, for example, the lens position may be determined to be satisfactory.

FIGS. 9A and 9B illustrate slit position measurement using the back walls 105L and 105R as the slit reference plane. FIG. 9A is a front view of the lens ferrule 31 illustrated with the yz coordinates. In FIG. 9A, the back walls 105L and 105R are shown with hatching. FIG. 9B schematically illustrates the measured dimensions in the yz coordinates. In FIG. 9A, the yz coordinates are defined on the plane including the back walls 105L and 105R. The y axis passes through the centers S_{L2} and S_{R2}. The z axis passes through the midpoint between the centers S_{L2} and S_{R2}.

The geometric relationships between the slit 97 and the centers S_{L2} and S_{R2} are as illustrated in FIG. 9B. Design positions of the opposite ends of the slit 97 in the y direction are at the same distance from the centers S_{L2} and S_{R2}, respectively, and the design positions of z-axis-wise opposite ends of the slit 97 are at the same distance from the y axis. On the other hand, upon the measurement, it is assumed that the shape of the slit 97 is determined such that the distance from the center S_{L2} to the −y end of the slit 97 is C, the distance from the center S_{L2} to the +z end of the slit 97 is D, the distance from the center S_{R2} to the +y end of the slit 97 is E, and the distance from the center S_{R2} to the −z end of the slit 97 is F. By comparing the measured dimensions of the slit with the design dimensions, the position of the slit in the y direction and in the z direction can be determined. For example, when the difference between the distance C and the distance E, and the difference between the distance D and the distance F are within an allowable range, the position of the slit may be determined to be satisfactory.

The functions and advantages of the present embodiment will be described. The x-axis position of the lens 94 or the slit 97 to be measured differs from the x-axis position of the contact face 91 used as a measurement reference. As a result, when the position of the lens 94 or the slit 97 and the positions of the centers of the through holes 95 are detected by using an image taken from the contact-face side to measure the position of the lens or the slit, an inclination of the ferrule relative to the imaging direction causes the measured positions and the measurement reference to be deviated from each other, thereby lowering measurement accuracy.

In contrast, the present embodiment uses the lens reference plane and the slit reference plane that are formed at different depths from the contact face 91 in the −x direction. More specifically, the back walls 99L and 99R formed at the same plane as the tops of the lenses 94 are used as the lens reference plane. Further, the back walls 105L and 105R, which are formed at the same plane as the back walls 101L and 101R and 100R at which the widthwise ends of the slit 97 are exposed, are used as the slit reference plane.

This configuration allows the measured positions and the measurement reference to be situated on the same plane. Parameters such as the distances A and B illustrated in FIG. 8B with respect to the position of the lens 94 and parameters such as the distances C through F illustrated in FIG. 9B with respect to the position of the slit 97 are thus measured accurately. Measurement accuracy of the important dimensions of the product is thus improved. In addition, placing the measurement reference on the same plane as the measured objects reduces the effect that slight displacements in the position and orientation of the ferrule at the time of measurement have on the lowering of measurement accuracy. High precision is thus not required for the position and orientation of the ferrule to ensure measurement accuracy, which serves to simplify the measurement process.

The recesses 104L and 104R allows the back walls 93L and 93R and the back wall 98 to be exposed when the lens ferrule 31 is viewed in the y direction as illustrated in FIG. 4. This enables easy measurement of the distance between the back wall 98, i.e., a slit end face, and the back walls 93L and 93R, i.e., the lens base, as well as the distance between the lens base and the contact face 91, i.e., a ferrule end face.

In the present embodiment, the center section of the slit 97 is exposed at the recesses 102L and 102R, so that the position of the center section in the z direction may be readily measured. Further, since the opposite ends of the slit 97 in the y direction are exposed at the grooves 100L and 100R, the z-axis position of these opposite ends may also be readily measured. Comparing the z-axis position of the center section of the slit 97 and the z-axis positions of the opposite ends of the slit 97 allows determination to be made with respect to whether the slit 97 is parallel to the y direction and whether there is any distortion such as curvature or the like, thereby improving the accuracy of product inspection.

The optical waveguide 20 is glued to the slit 97. In the present embodiment, the slit 97 is exposed toward the contact face 91 through the grooves 100L and 100R, so that an adhesive leaking from the slit 97 may flow into the through holes 95 via the recesses 104L and 104R. In consideration of this, the present embodiment has protrusions 106L and 106R, as illustrated in FIGS. 2 through 5, which protrude from the back walls 105L and 105R toward the −x direction at the boundaries between the recesses 104L and 104R and the grooves 100L and 100R. The protrusions 106L and 106R block the entire z-direction extension of the recesses 104L and 104R, and extend a certain length from the back walls toward the −x direction, thereby separating the recesses 104L and 104R from the grooves 100L and 100R. This arrangement prevents an adhesive from flowing into the through holes 95 through the recesses 104L and 104R even when the adhesive leaks from the slit 97 during assembling the ferrule 30.

The two recesses 92L and 92R are arranged side by side in the width direction in the contact face 91, so that there is no recess in the center of the contact face 91 in the width direction, with a rib 107 stretching across the entire extension in the z direction. Accordingly, a foreign object coming toward the recesses 92L and 92R while the contact face 91 is exposed hits the rib 107 before hitting the lenses 94, which protects the lenses 94 from being impacted by the foreign object. This provides satisfactory protection for the lenses 94.

As illustrated in FIGS. 2, 3, and 5, the inner circumferential surfaces of the through holes 95 have extending portions 108L and 108R at the +z side and the −z side with respect to the recesses 104L and 104R, such that the extending portions 108L and 108R extend toward the −x direction to the contact face 91. This reduces a gap with the MT ferrule 32 upon connection to the MT ferrule 32.

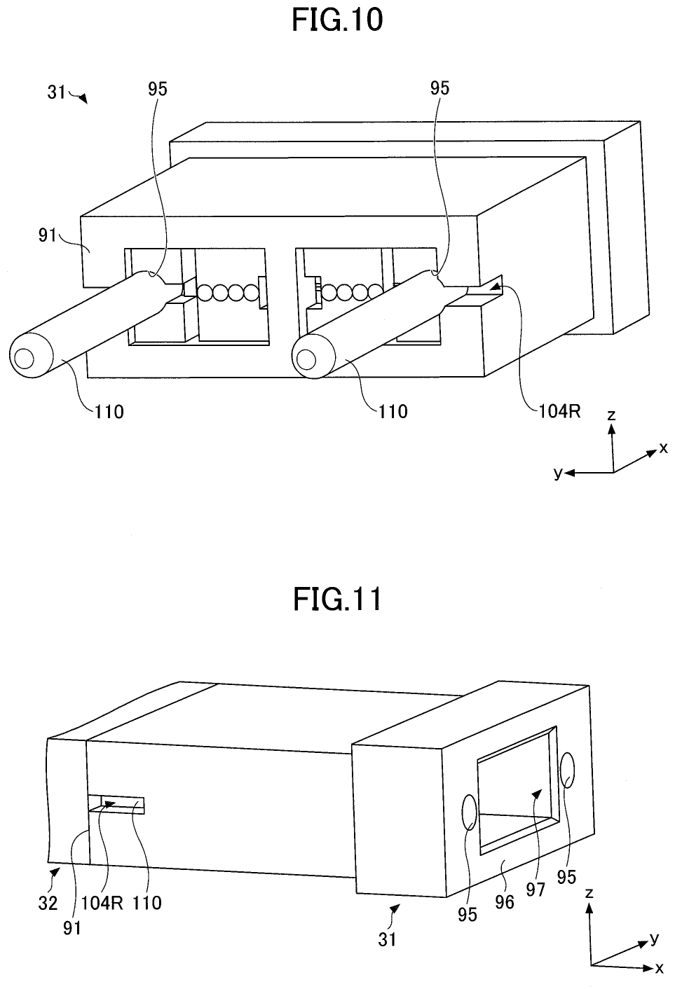

FIG. 10 is an oblique view of the lens ferrule 31 having the guide pins 110 mounted thereon. FIG. 11 is an oblique view illustrating the lens ferrule 31 and the MT ferrule 32 connected to each other.

Provision of the recesses 104L and 104R may give rise to a problem regarding waterproof property because the contact point with the MT ferrule 32 could be exposed. However, the recesses 104L and 104R of the present embodiment overlap the centers of the through holes 95, and have a dimension in the z direction that is smaller than the diameter of the through holes 95. As illustrated in FIG. 10, thus, the guide pins 110 serve to close the space created by the recesses 104L and 104R that would otherwise lead to the interior.

When the lens ferrule 31 is connected to the MT ferrule 32, the lens ferrule 31 is in close contact with the MT ferrule 32 as illustrated in FIG. 11, with the guide pins 110 inserted into the through holes of the MT ferrule 32. The gaps created by the recesses 104L and 104R, which are open on the outer surface upon connection to the MT ferrule 32, are completely closed by the guide pins 110. This arrangement ensures the waterproof property of the ferrule despite the presence of the recesses 104L and 104R. Further, foreign matter is prevented from intruding into areas around the lenses 94 via the recesses 104L and 104R, so that the lenses 94 are properly protected.

### [Variation]

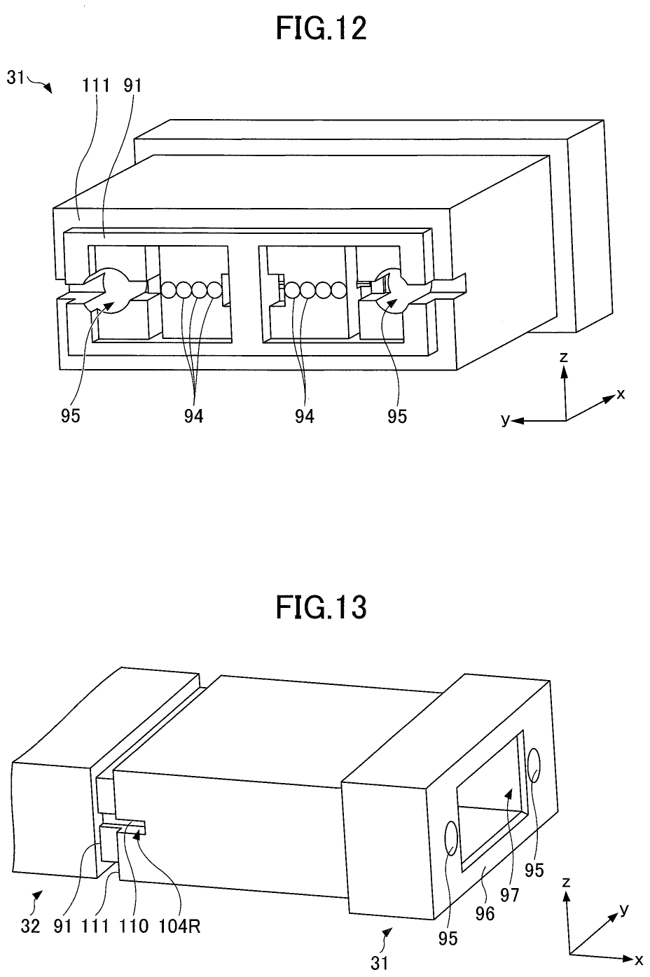

A first variation will be described with reference to FIGS. 12 and 13. FIG. 12 is an oblique view of the lens ferrule 31 according to the first variation. FIG. 13 is an oblique view illustrating the lens ferrule 31 of the first variation and the MT ferrule 32 connected to each other.

As illustrated in FIG. 12, a retracted face 111 may be cut into the contact face 91 toward the +x direction along the entire perimeter of the contact face 91. As illustrated in FIG. 13, when the lens ferrule 31 is connected to the MT ferrule 32, the retracted face 111 forms a groove along the entire perimeter of the connecting portion. Filling this groove with an adhesive enables secure closure of the gap between the lens ferrule 31 and the MT ferrule 32, and also reinforces the connection between the lens ferrule 31 and the MT ferrule 32.

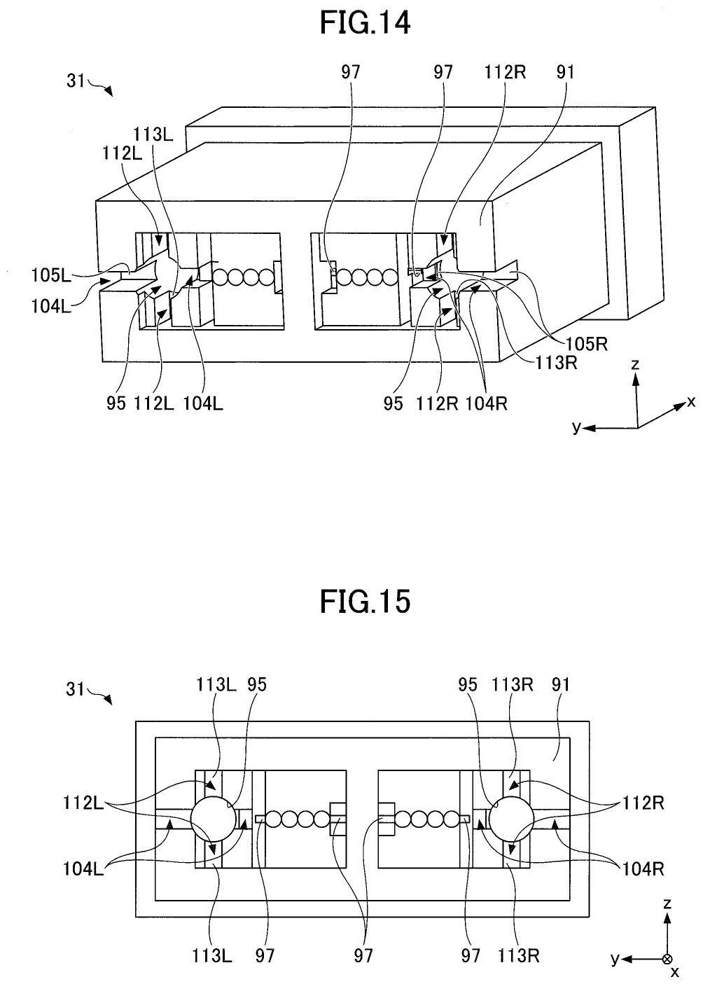

A second variation will be described with reference to FIGS. 14 and 15. FIG. 14 is an oblique view, and FIG. 15 is a front view of the lens ferrule 31 according to the second variation.

As illustrated in FIGS. 14 and 15, vertical recesses 112L and 112R intersecting the recesses 104L and 104R and the centers of the through holes 95 may be provided. The recesses 112L and 112R are parallel to the z axis and cut into the contact face 91 to the same depth as the recesses 104L and 104R. The recesses 112L and 112R and the recesses 104L and 104R form a substantially cross-shaped cross-section. Back walls 113L and 113R of the recesses 112L and 112R are at the same position in the x direction as the back walls 105L and 105R.

Accordingly, the back walls 113L and 113R can also be used as the slit reference plane, and areas usable as the slit reference plane are thus increased. The centers S_{L2} and S_{R2} serving as the reference for measuring the slit position are measured based on the shape and position of the contour of the through holes 95 on the slit reference plane, for example. As illustrated in FIGS. 14 and 15, increases in the areas usable as the slit reference plane increases the contour of the through holes 95 on the slit reference plane, thereby allowing the centers S_{L2} and S_{R2} to be measured more accurately. Improvement in the accuracy of measuring the centers S_{L2} and S_{R2}, which serve as the measuring reference, improves the accuracy of measuring the position of the slit 97.

The present embodiment has heretofore been described by referring to specific examples. The present disclosures are not limited to these specific examples. Those obtained by a skilled person in the art upon modifying these specific examples are also intended to be within the scope of the present disclosures as long as the features of the present disclosures are retained therein. The components of the noted specific examples as well as the positions, conditions, and shapes thereof are not limited to those described, and may be modified as appropriate. Combinations of the components of the noted specific examples may be modified and used as long as no technological conflict arises.

In the above-described embodiments, the back walls 99L and 99R serve as the lens reference plane, and the back walls 105L and 105R serve as the slit reference plane. Nonetheless, other planes may alternatively be used as the lens reference plane or the slit reference plane.

One or more of the back walls 99L and 99R, the grooves 100L and 100R, the recesses 102L and 102R, the recesses 104L and 104R, and the protrusions 106L and 106R of the embodiments may be removed.

In the embodiments described above, two recesses 92L and 92R are arranged on both sides of the rib 107. Alternatively, only one recess may be provided without the center rib 107.

The present application is based on and claims priority to Japanese patent application No. 2018-168848 filed on Sep. 10, 2018, with the Japanese Patent Office, the entire contents of which are hereby incorporated by reference.

What is claimed is:

1. A lens ferrule to be connected with a second ferrule, comprising:
a contact face that comes in contact with the second ferrule;
lenses disposed in a recess formed in the contact face;
an insertion face opposite the contact face and configured to receive an optical waveguide
a slit formed in the insertion face;
a through hole cut into the contact face and configured to receive a guide pin for positional alignment with the second ferrule;
a lens reference plane configured to serve as a reference for measuring positions of the lenses; and
a slit reference plane configured to serve as a reference for measuring a position of the slit,
wherein the lens reference plane and the slit reference plane are disposed at different depths from the contact face in an area including the through hole.

2. The lens ferrule as claimed in claim 1, wherein the recess has a center back wall on which the lenses are disposed, and an outer back wall configured to serve as the lens reference plane, and
wherein the lens reference plane is positioned at a same plane as tops of the lenses.

3. The lens ferrule as claimed in claim 1, further comprising:
a groove situated at a position overlapping an end of the slit and cut into the contact face to a depth at which the end of the slit is exposed; and
a side recess intersecting a center of the through hole and cut into the contact face to a same depth as the groove,
wherein the slit reference plane is a back wall of the side recess.

4. The lens ferrule as claimed in claim 3, further comprising a center recess situated at a position overlapping a center section of the slit and cut into the contact face to a depth at which the center section of the slit is exposed.

5. The lens ferrule as claimed in claim 3, further comprising a protrusion protruding from the back wall of the side recess at a boundary between the side recess and the groove to separate the side recess from the groove.

6. The lens ferrule as claimed in claim 3, further comprising a vertical recess intersecting both the side recess and the center of the through hole, and cut into the contact face to a same depth as the side recess.
